(19) United States
(12) Patent Application Publication
(10) Pub. No.: US 2004/0236902 A1
(43) Pub. Date: Nov. 25, 2004

(54) DATA DISTRIBUTION IN CONTENT ADDRESSABLE MEMORY

(75) Inventors: Paul C. Cheng, San Jose, CA (US); Nelson L. Chow, Mountain View, CA (US)

Correspondence Address: INTELLECTUAL PROPERTY LAW OFFICE, 1901 S. BASCOM AVENUE, SUITE 660, CAMPBELL, CA, 95008, US

(73) Assignee: INTEGRATED SILICON SOLUTION, INC., Santa Clara, CA (US)

(21) Appl. No.: 10/249,922

(22) Filed: May 19, 2003

(51) Int. Cl. G06F 12/00

(52) U.S. Cl. 711/108; 711/5

(57) ABSTRACT

A data distribution system suitable for use in a content addressable memory (CAM) search engine have a number of CAM units. A set of bank multiplexers each includes a set of multiplexing constructs that are controllable via respective bank control buses. Input data for storage in the CAM units as file data or for searching against pre-stored file data are provided to the bank multiplexers and the bank control buses direct the multiplexing constructs to selectively pass sub-portions of the input data onward to the CAM units thus distributing some or all of the input data to the CAM units, with the input data configurably ordered as desired, configurably duplicated as desired, or both. Optionally, a configuration register can hold multiple sets of programming data for loading onto the bank control buses to direct the multiplexing constructs, thus facilitating different distributions of the input data to the CAM units.

### BACKGROUND OF INVENTION

1. Technical Field

The present invention relates generally to static information storage and retrieval systems, and more particularly to associative memories, which are also referred to as content or tag memories.

2. Background Art

In a content addressable memory (CAM) search engine files of data words (i.e., entries) are stored in tables to be searched against input data. If the CAM search engine stores files with data words having only certain convenient widths, based on the physical layout of the memory banks, it is relatively straightforward to send the input data to each memory bank of the CAM search engine.

FIG. 1 (background art) is a block diagram showing an example CAM search engine 10 where four memory banks 12 (MB_1 through MB_4) are each configured as a K-bits “wide” by M-words “deep”. The input data here is first latched in a mask register 14 (MASK_REG) that sets certain bits to constant values, and the output of the mask register 14 is then sent to all four memory banks 12 to be compared with the M-words stored in each.

The widths of the memory banks 12 define the width of the data file or files that can be stored and searched in the CAM search engine 10. For example, if K=256 and M=1024, the CAM search engine 10 can hold one file that is 256-bits wide by 4096-words (M*4) deep. Conversely, this simple CAM search engine 10 cannot hold a file that is 128-bits by 8192-words (M*8) or 512-bits by 512-words (M/2). Similarly, the CAM search engine 10 here could also hold four files that are 256-bits wide by 1024-words (M*1) deep, but not hold both a 128-bit by 4096-word file along with a 512-bit by 256-word file.

A typical search engine application today may also have one or more sub-fields of the input data that need to distributed with reordering, and the CAM search engine 10 in FIG. 1 clearly cannot handle that. Such reordering may require that non “contiguous” sub-fields be treated as contiguous when distributed for loading or use for searching, and higher-order portions may also need to be placed “below” lower-order portions as well. Somewhat related to this, duplication of some or all of sub-fields may also be needed.

Still further, modern applications increasingly need to support data distribution in a time-critical context. The input data may need to be subdivided into different groups of sub-fields, with sub-fields in the same group processed simultaneously while the groups themselves are processed in order. Fore instance, at one point in time one such group may need to be processed, while at a close second point in time, e.g., in the next clock cycle, a different group is processed. Facilitating the definition of such groups and distributing them is also beyond the capability of the simple CAM search engine 10 in FIG. 1.

In addition, an increasingly important need for flexible data distribution is to support multiple, parallel lookups per clock cycle. For example, application performance requirements may necessitate that sub-fields having the same input data are searched against multiple data files concurrently. There is more to this than just data distribution. For example, match priority encoding is needed (as it is if the CAM search engine 10 in FIG. 1 is used to store multiple data files). However, as solutions to such other aspects of the problem are emerging, improving data distribution is becoming more important.

### SUMMARY OF INVENTION

Accordingly, it is an object of the present invention to provide a data distribution system able to better to support both the content-varying and the time-varying nature of input data used in modern applications.

Briefly, one preferred embodiment of the present invention is a circuit for distributing input data to a number of content addressable memory (CAM) units each having a respective CAM data bus. A plurality of bank multiplexers are provided, corresponding in number with the CAM units. Each bank multiplexer is able to receive the input data into a number of multiplexing constructs, and each bank multiplexer has a bank control bus common to its respective multiplexing constructs. Each multiplexing construct is able to pass a portion of the input data onto the CAM data bus of the corresponding CAM unit, responsive to its bank control bus.

Briefly, another preferred embodiment of the present invention is a method for distributing input data to a number of CAM units each having a CAM data bus. The input data is provided to each of a set of multiplexing constructs, wherein sub-sets of the multiplexing constructs are associated with respective of the CAM units. A sub-portion of the input data is then selectively passed through each multiplexing construct. The sub-portions of the input data that have passed through each respective sub-plurality of the multiplexing constructs is combined into a respective bank data set. And, the respective bank data sets are delivered to their respectively associated CAM units.

An advantage of the present invention is that it provides the ability to distribute some or all of the input data to the CAM units, with the input data configurably ordered as desired, configurably duplicated as desired, or both.

Another advantage of the invention is that it may rapidly be configured and reconfigured, thus facilitating flexible data distribution in time critical applications.

Another advantage of the invention is that it may support multiple, parallel distribution operations, concurrently.

And another advantage of the invention is that it may integrate well with conventional or sophisticated emerging schemes also used in CAM-based search engines, such as pipelined architecture memory bank linking and search engine cascading.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF DRAWINGS

The purposes and advantages of the present invention will be apparent from the following detailed description in conjunction with the appended figures of drawings in which:

FIG. 1 (background art) is a block diagram showing an example CAM search engine where four memory banks 12 are each configured as a K-bits “wide” by M-words “deep”.

FIG. 2 is a block diagram showing a data distribution system according to the present invention.

FIG. 3 is a block diagram showing details of the bank multiplexers in the embodiment FIG. 2.

FIG. 4 is a block diagram showing details of the register multiplexers in the embodiment in FIG. 2.

FIG. 5 stylistically depicts a simple case wherein only 64 bits of input data are routed for comparison against (or loading into) the CAM units.

FIG. 6 stylistically depicts a more complex case, where 64 bits in one set of input data is provided and 32 bits in another set of input data is also provided.

FIG. 7 stylistically depicts a more complex case still, where 64 bits in one set of input data is provided, another 32 bits in a second set of input data is provided, some of the input data is not used, and 128 bits in a third set of input data is also provided.

FIG. 8 stylistically depicts an overview of a typical search scenario.

FIG. 9 is a block diagram depicting how the data distribution system can be used in the greater context of a CAM search engine.

FIG. 10 is a partial block diagram depicting how the present invention may particularly work with dynamic bank linking.

FIG. 11 stylistically depicts an overview of a search scenario using 640-bit wide input data in the data distribution system shown in FIG. 10.

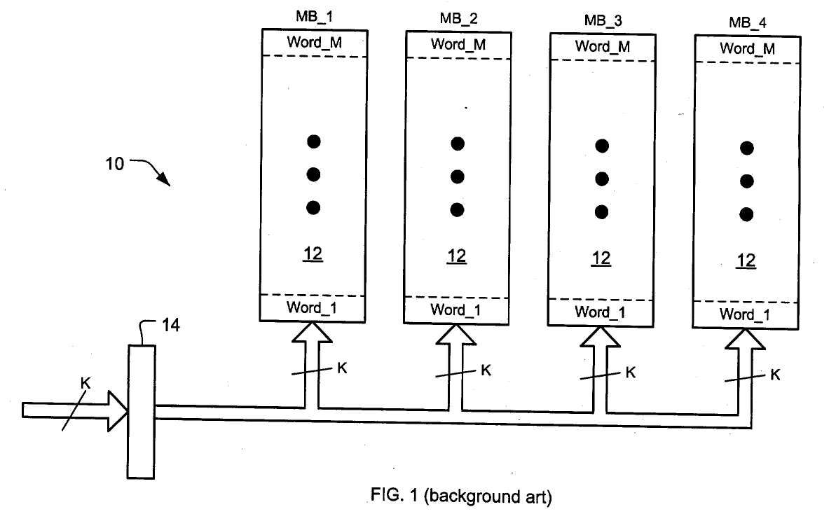

In the various figures of the drawings, like references are used to denote like or similar elements or steps.

### DETAILED DESCRIPTION

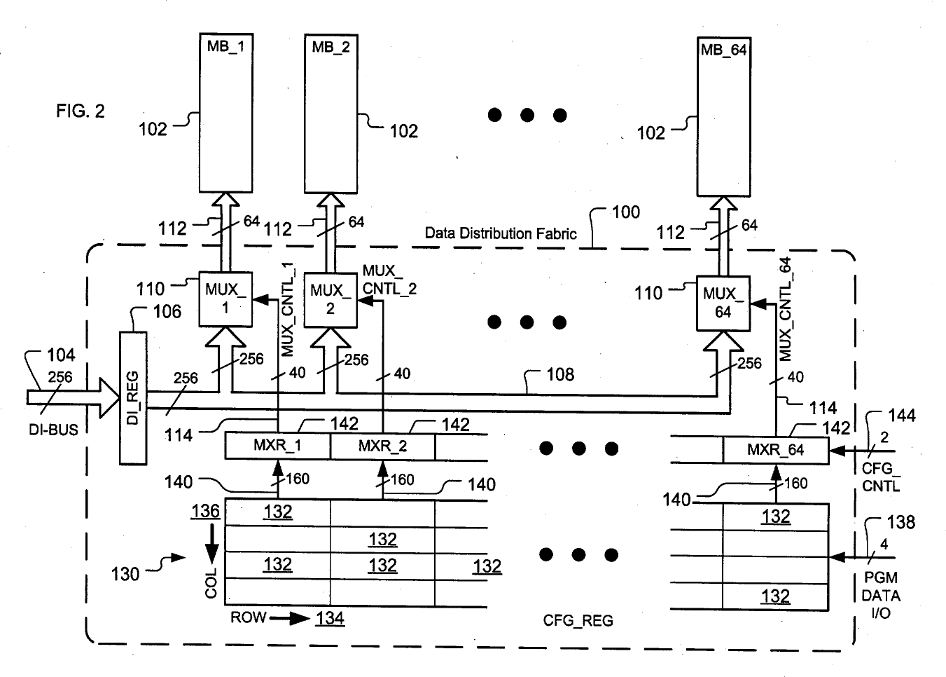

A preferred embodiment of the present invention is a fabric or system for distribution of data files, including variable-width data files, in a content addressable memory (CAM). As illustrated in the various drawings herein, and particularly in the view of FIG. 2, a preferred embodiment of the invention is depicted by the general reference character 100.

FIG. 2 is a block diagram showing a data distribution system 100 for variable sized data. The inventive data distribution system 100 in this example includes 64 CAM units 102 (MB_1 through MB_64), which the data distribution system 100 delivers input data to for loading or searching. The CAM units 102 here are each 64 bits “wide” and M-words “deep”.

The input data is delivered into the data distribution system 100 via a 256-bit input data bus 104 (DI_BUS) that is connected to a 256-bit input data register 106 (DI_REG). The input data register 106 latches all 256 bits of the input data and sends it onward on a main data bus 108 to 64 bank multiplexers 110 (MUX_1 through MUX_64), one per CAM unit 0.102. The bank multiplexers 110 each connect to their respective CAM units 102 by 64-bit wide bank data buses 112, and the bank multiplexers 110 are controlled via respective 40-bit bank control buses 114 (MUX_CNTL_1 through MUX_CNTL_64). Consequentially, each CAM unit 102 can be provided with 64 bits of input data taken from the main data bus 108.

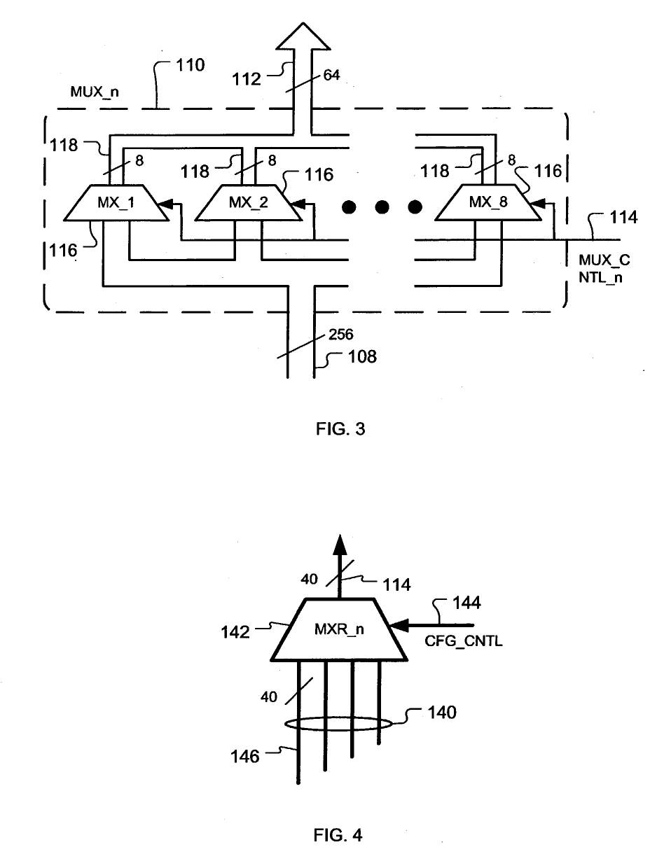

FIG. 3 is a block diagram showing details of the bank multiplexers 110 in FIG. 2. Each bank multiplexer 110 includes eight multiplexing constructs 116 (MX_1 to MX_8), each able to pass an 8-bit portion of input data from the 256-bit main data bus 108 to a respective 8-bit bank sub-bus 118. The eight 8-bit wide bank sub-buses 118 combine to form the 64-bit wide bank data bus 112, which carries the output of the bank multiplexer 110 to its respective CAM unit 102.

Which particular 8-bit portions of the 256 bits of available input data that the multiplexing constructs 116 each pass is controllable via the bank control bus 114 (MUX_CNTL_1 through MUX_CNTL_64) for the respective bank multiplexer 110. Since the 256 bits of input data are dealt with in 8-bit portions, there are 32 (2⁵) different ways in which each multiplexing construct 116 can be configured. Accordingly, each of the eight multiplexing constructs 116 is controlled by 5 bits of the 40-bit bank control bus 114, and any 8-bit portions of the input data are directable to any 8-bit section of the CAM unit 102 by the bank multiplexer 110.

With reference again to FIG. 2, a configuration register 130 (CFG_REG) is further provided. The configuration register 130 includes 40-bit cells 132 organized in four rows 134 (ROW) and 64 columns 136 (COLUMN). The number of rows 134 is a matter of design choice, while the number of columns 136 corresponds to the number of bank control buses 114.

Programming data is loaded into the cells 132 of the configuration register 130 via a 4-bit wide programming data bus 138 (PGM DATA I/O). Since there are 64 columns 136 of the 40-bit cells 132, loading each row 134 entails loading up to 2,560 bits of programming data.

A series of 160-bit wide register sub-buses 140 carry program data from the cells 132 in the 64 respective columns 136 to 64 register multiplexers 142 (MXR_1 through MXR_64). The register multiplexers 142 then pass the program data in one row 134 of 64 cells 132 to the respective 64 bank control buses 114, as directed via a 2-bit configuration control bus 144 (CFG_CTRL).

FIG. 4 is a block diagram showing details of the register multiplexers 142 in FIG. 2. The register sub-bus 140 can be viewed as having four 40-bit bus-segments 146, wherein each bus-segment 146 carries the programming data from one cell 132 in one row 134 of one respective column 136 of the configuration register 130. Under direction of the commonly connected configuration control bus 144, the register multiplexers 142 then operate in straightforward manner to select which row 134 of program data will be taken from and passed onto the bank control bus 114.

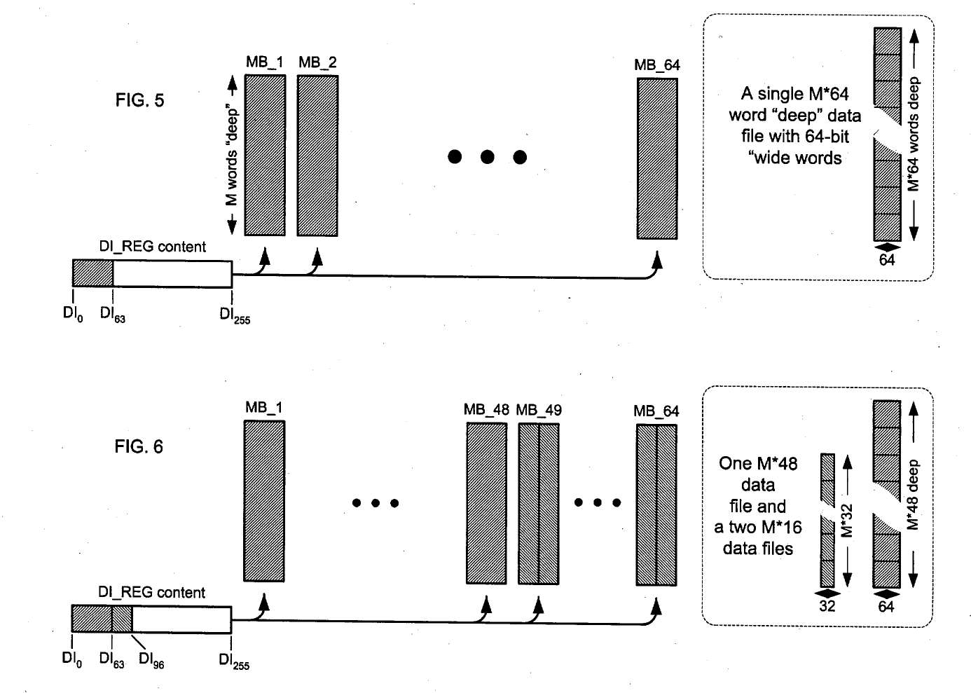

FIG. 5-8 are block diagrams showing usage examples based on the data distribution system 100. For discussion, the 256-bits width-wise “across” the input data bus 104 in these examples are defined as DI₀ through DI₂₅₅.

FIG. 5 stylistically depicts a simple case wherein only 64 bits of input data on DI₀₋₆₃ is routed for comparison against (or loading into) the CAM units 102. Each CAM unit 102 here might hold one 64-bit wide, M-word deep data file. The input data on DI₀₋₆₃ might even be compared with 64 such 64-bit wide, M-word deep data files concurrently here. Alternately, the multiple CAM units 102 here may hold larger data files, also 64 bits wide but M*n words deep (where n=<64). Or, as depicted in the insert in FIG. 5, all of the CAM units 102 may hold a single 64-bit wide data file that is M*64 words deep.

Programming the data distribution system 100 to apply the input data on DI₀₋₆₃ in the manner just described merely requires that the bank multiplexers 110 be programmed the same via their respective bank control buses 114, to each have their first multiplexing constructs 116 all pass DI₀₋₇, their second multiplexing constructs 116 all pass DI_{8/15}, and so forth, with their eighth multiplexing constructs 116 all passing DI₅₆₋₆₃. Whether one or multiple data files are stored in the CAM units 102 is largely a matter of definition, although prioritizing among multiple matches typically needs to be performed for each data file. Match prioritization is discussed presently.

FIG. 6 stylistically depicts a somewhat more complex case, one where 64 bits in one set of input data is provided on DI₀₋₆₃ and 32 bits in another set of input data is provided on DI₆₄₋₉₆. The first 48 CAM units 102 (MB_1 through MB_48) here have been configured to hold a first data file for comparison against the input data provided on DI₀₋₆₃, while the remaining 16 CAM units 102 (MB_49 through MB_64) have been configured to hold a second data file for comparison against the input data provided on DI₆₄₋₉₆. In particular, however, this second data file is 32 bits wide and M*32 words deep, thus efficiently using all of the available capacity in the last 16 CAM units 102 (MB_49 through MB_64).

How the first 48 CAM units 102 (MB_1 through MB_48) and the input data provided on DI₀₋₆₃ are used generally follows from the discussion of FIG. 5. However, instead of programming all 64 of the bank multiplexers 110, as was done for the example in FIG. 5, this programming is now used for only the first 48 bank multiplexers 110. The remaining 16 bank multiplexers 110 are each programmed instead to have their first and fifth multiplexing constructs 116 all pass DI₆₄₋₇₁, their second and sixth multiplexing constructs 116 to all pass DI₇₂₋₇₉, their third and seventh multiplexing constructs 116 to all pass DI₈₀₋₈₇, and their fourth and eighth multiplexing constructs 116 to all pass DI₈₈₋₉₅. The result of this programming is depicted in the insert in FIG. 6.

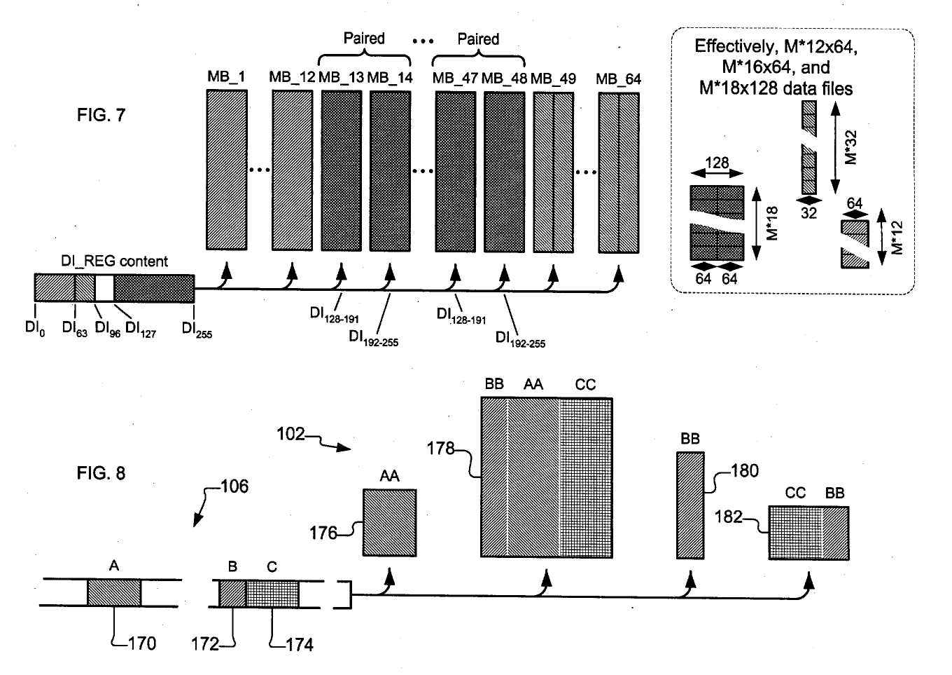

FIG. 7 stylistically depicts a still more complex case, one where 64 bits in one set of input data is provided on DI₀₋₆₃, another 32 bits in a second set of input data is provided on DI₆₄₋₉₆, DI₉₆₋₁₂₇ are not used, and 128 bits in a third set of input data is provided on DI₁₂₈₋₂₅₅. Here a collection of 12 CAM units 102 (MB_1 through MB_12) has been configured for use with the data from DI₀₋₆₃, another collection of 16 CAM units 102 (MB_49 through MB_64) has been configured for use with the data from DI₆₄₋₉₆, and yet another collection of 36 CAM units 102 (MB_13 through MB_48) has been configured for use with the data from DI₁₂₈₋₂₅₅.

How the first 12 CAM units 102 (MB_1 through MB_12), with the DI₀₋₆₃ input data, and how the last 16 CAM units 102 (MB_49 through MB_64), with the DI₆₄₋₉₆ input data, are used generally follows from the discussions of FIG. 5-6. Here it is the “middle” collection of 36 CAM units 102 (MB_13 through MB_48) that is of particular interest. Since these CAM units 102 are 64 bits wide and 128 bits of input data is provided on DI₁₂₈₋₂₅₅, this middle collection of CAM units 102 may be view conceptually as being configured in pairs. For instance, the 13th and 14th CAM units 102 (MB_13 and MB_14) are configured as such a pair in FIG. 7 (although, there is no requirement that pairs be physically contiguous). Programming the middle collection of 36 CAM units 102 (MB_13 through MB_48) involves instructing the bank multiplexers 110 to apply DI₁₂₈₋₁₉₁ to one CAM unit 102 in each pair, and DI₁₉₂₋₂₅₅ to the other CAM unit 102 in the respective pair. The result is depicted in the insert in FIG. 7.

Summarizing, the example in FIG. 5 illustrates how the inventive data distribution system 100 permits configuring the available CAM units 102 depth-wise. The CAM units 102 thus may be used for as little as one very “deep” M*64 word file, or for multiple “shallow” M*16 word files. The example in FIG. 6 builds upon this, and illustrates how the data distribution system 100 permits configuring the available CAM units 102 width-wise in units of width narrower than the 64-bit widths of the CAM units 102. The example in FIG. 7 builds further, illustrating how the data distribution system 100 permits configuring the available CAM units 102 width-wise in units of width greater than the 64-bit widths of the CAM units 102. Taken to a logical extreme, from the cases in FIGS. 5-6 it follows that the CAM units 102 might be configured as one very, very deep M*512 word file where the words are 8 bits wide, or as 512 M-word deep files where the words are also 8 bits wide. Also taken to a logical extreme (albeit one that simple component additions can improve upon further, as discussed presently), from the case in FIG. 7 it follows that the CAM units 102 might be configured for one 256-bit wide and M*16 word deep data file or for 16 data files that are 256 bits wide and M-words deep.

In passing, it should be noted that the choice of the 64-bit wide CAM units 102, the 256-bit wide input data bus 104, and the 8-bit wide portions taken from the input data bus 104 are all matters of mere design preference rather than limitations. Different sizes can easily be used instead. For example, 32-bit wide or 96-bit wide CAM units could be used, or combinations of CAM unit widths could be employed. These or other embodiments of the invention may also be constructed that use 48-bit wide or 512-bit wide input data buses, for instance. And these or still other embodiments of the invention may also be constructed that handle 32-bit, 4-bit, 2-bit, or even 1-bit wide data portions taken from the input bus.

FIG. 8 stylistically depicts an overview of a typical search scenario. The input data register 106 here has been loaded with data that includes a first field 170 (A), a second field 172 (B), and a third field 174. The CAM units 102 have been loaded with a first database 176, a second database 178, a third database 180, and a fourth database 182. The first database 176 contains a pre-stored file With data (AA) that the first field 170 (A) is to be searched against. The second database 178 contains a pre-stored file with a part being more data (AA) that the first field 170 (A) is to also be searched against, another part being data (BB) that second field 172 (B) is to be searched against, and another part being data (CC) that third field 174 (C) is be searched against. The third database 180 contains a pre-stored file with yet more data (BB) that the second field 172 (B) is to also be searched against. Finally, the fourth database 182 contains a pre-stored file with still more data (BB) that the second field 172 (B) is to also be searched against, and also still more data (CC) that the third field 174 (C) is to further be searched against.

With reference now back to FIG. 2-4, as well as continued reference to FIG. 5-8, we now have a context with which to discuss the configuration register 130. One simple register could be used to provide the necessary signals on the bank control buses 114 for programming the inventive data distribution system 100 to search data in any of the manners described for FIG. 5-8, or for programming it to search in any of a myriad of other manners. However, recall that it was noted above that loading each row 134 in the configuration register 130 entails loading up to 2,560 bits of programming data. This takes considerable time, and if one wants to load or search data in different ways, having to wait many clock cycles while programming data is loaded may be unacceptable. Use of the configuration register 130 overcomes this limitation, by permitting pre-loading of multiple sets of programming data via the programming data bus 138 and then rapidly selecting from among and using one of those sets via the configuration control bus 144.

For example, the CAM units 102 might be loaded with data files as they were in the examples FIG. 5-8. The input data register 106 might then be loaded with input data as it was in the examples FIG. 5-7. With the cells 132 in three rows 134 of the configuration register 130 already programmed, each of the three different searches in the examples in FIG. 5-7 can then be performed in a single clock cycle each, or all three can be performed in as little as three clock cycles. Furthermore, the input data register 106 might then be reloaded with the input data as it was in the example in FIG. 8 and, with the fourth row 134 of the configuration register 130 already programmed for this, that new set of input data could be searched against the contents of the CAM units 102 on the very next clock cycle.

Of course, it is a simple matter to provide and employ a different size configuration register, programming data bus, or configuration control bus. For instance, a 16-row configuration register, a 16-bit programming data bus, and a 4-bit configuration control bus might be used.

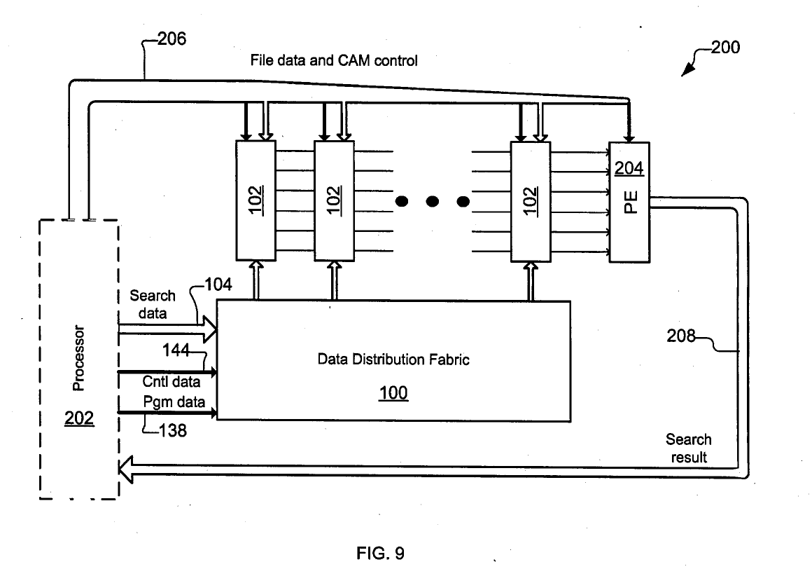

Moving on now to FIG. 9, this is a block diagram depicting how the data distribution system 100 of FIG. 2 can be used in the greater context of a CAM search engine 200. A processor 202 (usually not part of the search engine proper, hence shown in dashed outline here) provides file data and CAM control data to the CAM units 102 and a priority encoder 204 via a CAM control bus 206. The processor 202 provides the search data to the data distribution system 100 on the input data bus 104, and also provides register programming data on the programming data bus 138 and register control data on the configuration control bus 144. The priority encoder 204 returns search results to the processor 202 via a result bus 208. [Alternately, the file data can be distributed to the CAM units via the input data bus 104, simplifying the CAM control bus 206. The inventors' presently preferred embodiment uses the inventive data distribution system 100 in the manner depicted in FIG. 9, but the spirit of the present invention fully encompasses the just noted alternate as well.] The inventive data distribution system 100 may work with conventional priority encoding schemes and circuitry, or with another invention by the current inventors that is the subject of co-pending U.S. patent application Ser. No. 10/249,598, titled “Dynamic Linking of Banks in Configurable Content Addressable Memory Systems” and filed Apr. 23, 2003.

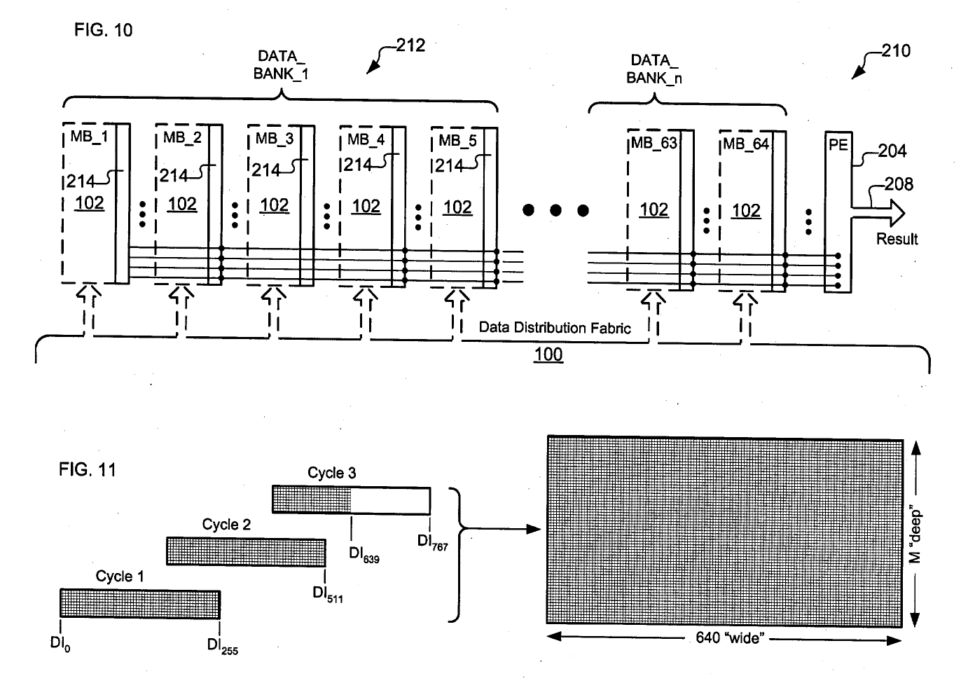

FIG. 10 is a partial block diagram depicting how the present invention may particularly work with dynamic bank linking 210. The CAM units 102 have here been configured as a first data bank 212, etc. (DATA_BANK_1 through DATA_BANK_n). Each CAM unit 102 includes a linking unit 214. The priority encoder 204 and the result bus 208 are also shown here, but other extraneous detail has been omitted for clarity.

FIG. 11 stylistically depicts an overview of a search scenario using 640-bit wide input data in the data distribution system 100 particularly shown in FIG. 10. For discussion here the 768 bits (3*256) width-wise across the input data bus 104 in 3 cycles are defined as DI₀₋₇₆₇. The CAM units 102 in the first data bank 212 have here been pre-loaded with a single 640-bit wide, M word deep data file. The first 256 bits of the input data, DI₀₋₂₅₅ are received in a first cycle and searched against the first 256 bits of the 640-bit wide words in the first and second CAM units 102 (MB_1 and MB_2), and the result set of this is latched in the linking unit 214 of the second CAM unit 102 (MB_2). Next, the second 256 bits of the input data, DI₂₅₆₋₅₁₁ are received in a second cycle and searched against the next 256 bits of the 640-bit wide words in the third and fourth CAM units 102 (MB_3 and MB_4). The result set of this is combined with the prior result set from the linking unit 214 of the second CAM unit 102 (MB_2), and a new result set is latched in the linking unit 214 of the fourth CAM unit 102 (MB_4). The last 128 bits of the input data, DI₅₁₂₋₆₃₉ are received in a third cycle and searched against the final 128 bits of the 640-bit wide words in the fifth CAM unit 102 (MB_5). The result set of this is combined with the prior result set from the linking unit 214 of the fourth CAM unit 102 (MB_4), and a new result set is now present in the linking unit 214 of the fifth CAM unit 102 (MB_5). This result set is available to the priority encoder 204, where one result of the 640-bit search here can be selected and provide on the result bus 208 for further use.

Summarizing, the CAM search engine 200 (FIG. 9) and the data distribution system 100 (FIG. 2) can be used with any size of input data down to the minimum increment that has been set (8 bits in the exemplary embodiments herein). Alternately, the CAM search engine 200 and the data distribution system 100 can also be used to distribute any size of input data up to the width-wise maximum capacity of the CAM units 102 (4096 bits in the exemplary embodiments herein). The dynamic bank linking 210 (FIG. 10) pipelined architecture according to the present inventors prior invention can be used for this, or the data distribution system 100 can be used with other linking and prioritizing system for this.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

1. A circuit for distributing input data to a plurality of content addressable memory (CAM) units each having a respective CAM data bus, comprising:
a plurality of bank multiplexers corresponding with the plurality of CAM units, wherein each said bank multiplexer is able to receive the input data into a plurality of multiplexing constructs and each said bank multiplexer has a bank control bus common to its respective said plurality of multiplexing constructs; and
wherein each said multiplexing construct is able to pass a portion of the input data onto the CAM data bus of the corresponding CAM unit responsive to its said bank control bus, thereby providing the ability for said plurality of bank multiplexers to distribute some or all of the input data to the plurality of CAM units with the input data configurably ordered as desired, configurably duplicated as desired, or both.

2. The circuit of claim 1, further comprising:
an input register suitable for receiving and latching the input data; and
a main data bus suitable for providing the input data from said input register to said plurality of bank multiplexers.

3. The circuit of claim 1, further comprising a configuration register suitable for storing programming data suitable to drive said bank control buses.

4. The circuit of claim 3, wherein said control register includes:
a plurality of rows of storage cells, wherein each said row is able to store one set of said programming data;
a plurality of register multiplexers corresponding with said plurality of bank multiplexers and having a common configuration control bus; and
wherein said plurality of register multiplexers are able to pass a said set of said programming data from a said row to said plurality of bank multiplexers responsive to said common configuration control bus.

5. A method for distributing input data to a plurality of content addressable memory (CAM) units each having a CAM data bus, the method comprising the steps of:
(a) providing the input data to each of a plurality of multiplexing constructs, wherein sub-pluralities of said multiplexing constructs are associated with respective of the CAM units;
(b) selectively passing a sub-portion of the input data through each said multiplexing construct;
(c) combining said sub-portions of the input data that have passed through each respective said sub-plurality of multiplexing constructs into a bank data set; and
(d) delivering said respective bank data sets to their respectively associated CAM units.

6. The method of claim 5, wherein said step (a) includes latching the input data.

7. The method of claim 5, wherein said step (b) includes controlling said selectively passing of said sub-portions of the input data responsive to a pre-stored set of programming data.

8. The method of claim 5, further comprising:
prior to said step (a), storing a plurality of sets of programming data;
prior to said step (b), choosing one of said plurality of sets of programming data to be control data; and wherein said step (b) includes controlling said selectively passing of said sub-portions of the input data responsive to said control data.

9. The method of claim 5, wherein said step (b) includes passing all of the input data as said sub-portions, thereby controllably distributing all of the input data to the CAM units.

10. The method of claim 5, wherein said step (b) includes passing less than all of the input data as said sub-portions, thereby controllably distributing only some of the input data to the CAM units.

11. The method of claim 5, wherein said step (b) includes passing some of the input data as multiple of said sub-portions, thereby controllably duplicating distribution of some of the input data to the CAM units.

12. The method of claim 5, wherein said step (b) includes passing at least one same said sub-portion through all said sub-pluralities of said multiplexing constructs, thereby controllably distributing the input data in said at least one same said sub-portion to all of the CAM units.

13. The method of claim 5, wherein said step (b) includes passing same said sub-portions through all said sub-pluralities of said multiplexing constructs, thereby controllably distributing the input data in said same said sub-portions to all of the CAM units.

14. The method of claim 5, wherein said step (b) includes passing different said sub-portions through at least some of said sub-pluralities of said multiplexing constructs, thereby controllably distributing the input data in said different said sub-portions differently to the CAM units.

15. The method of claim 5, wherein:
said sub-portions each have a differing initial ordinality defined by where it corresponds with the input data as well as a differing final ordinality defined by where it corresponds with a said bank data set; and
said step (c) includes reordering said initial ordinalities and said final ordinalities of at least two said sub-portions.

16. A circuit for distributing input data to a plurality of content addressable memory (CAM) units each having a respective CAM data bus, comprising:
a plurality of multiplexing construct means, wherein sub-pluralities of said multiplexing construct means are associated with respective of the CAM units;
means for providing the input data to each of said plurality of multiplexing construct means;
means for selectively passing a sub-portion of the input data through each said multiplexing construct means;
means for combining said sub-portions of the input data that have passed through each respective said sub-plurality of multiplexing construct means into a bank data set; and
means for delivering said respective bank data sets to their respectively associated CAM units.

17. The circuit of claim 16, further comprising:
means for storing a plurality of sets of programming data;
means for choosing one of said plurality of sets of programming data to be control data; and wherein said means for selectively passing controls said passing of said sub-portions of the input data responsive to said control data.
